(19) United States
(12) Patent Application Publication
(10) Pub. No.: US 2014/0333818 A1
(43) Pub. Date: Nov. 13, 2014

(54) APPARATUS AND METHOD FOR COMPOSING MOVING OBJECT IN ONE IMAGE

(71) Applicant: Samsung Electronics Co., Ltd, Gyeonggi-do (KR)

(72) Inventors: Jae-Sik Sohn, Gyeonggi-do (KR); Ki-Huk Lee, Gyeonggi-do (KR)

(73) Assignee: Samsung Electronics Co., Ltd, Gyeonggi-do (KR)

(21) Appl. No.: 14/070,348

(22) Filed: Nov. 1, 2013

(30) Foreign Application Priority Data
May 8, 2013 (KR) 10-2013-0051917

(51) Int. Cl. H04N 5/232

(52) U.S. Cl. CPC H04N 5/23293
USPC 348/333.05

(57) ABSTRACT

An apparatus and a method for composing a moving object in one image. The method includes: detecting one or more movement areas from one or more continuously input images; determining whether the detected one or more movement areas are usable for composing; storing location information of the one or more movement areas together with images corresponding to the detected one or more movement areas when the one or more movement areas are usable; generating a composite image by using images corresponding to the stored one or more movement areas and the location information of the one or more movement areas; and displaying the generated composite image on a preview screen area located in a display screen. The method reduces storage space required for image composing and rapidly composes in a smaller amount of processing time.

### CROSS-REFERENCE TO RELATED APPLICATION(S) AND CLAIM OF PRIORITY

The present application is related to and claims the priority under 35 U.S.C. §119(a) to Korean Application Serial No. 10-2013-0051917, which was filed in the Korean Intellectual Property Office on May 8, 2013, the entire content of which is hereby incorporated by reference.

### TECHNICAL FIELD

The present disclosure relates to an apparatus and a method for image composing, and more particularly, to an apparatus and a method for composing a moving object in one image.

### BACKGROUND

Generally, an image composing apparatus continuously takes and stores one or more images according to time differences by a camera in a state where the camera is fixed to a background, in order to express a continuous movement of an object in one image by continuously photographing the moving object through the camera. An image composing apparatus distinguishes the moving object from the background by comparing the stored one or more images, and determines whether the moving object in each of the images overlap each other. Then, the image composing apparatus deletes images in which moving objects overlap each other, stores images in which moving objects do not overlap each other, extracts the moving objects from the stored images, and then composes the extracted objects on one background image.

As described above, the image composing apparatus stores one or more continuously photographed images, extracts the non-overlapping moving objects from the stored images, and composes the extracted moving objects on a background image.

A large storing space is required in order to store the continuously photographed one or more images, and much time is required in order to write or read the stored one or more images.

To analyze and compose all of the continuously photographed one or more images requires too much time.

### SUMMARY

To address the above-discussed deficiencies, embodiments of the present disclosure provide an apparatus and method for composing a moving object in one image, which can save a storing space used for image composing and can achieve fast composing with a small amount of processing time.

Certain embodiments of the present disclosure provide an apparatus for composing a moving object in one image. The apparatus includes: a camera unit that continuously photographs one or more images; and a controller that detects one or more movement areas from one or more images input through the camera unit, determines whether the detected one or more movement areas are usable for composing, stores location information of the one or more movement areas together with images corresponding to the detected one or more movement areas when the one or more movement areas are usable, generates a composite image by using images corresponding to the stored one or more movement areas and the location information of the one or more movement areas, and displays the generated composite image on a preview screen area located in a display screen.

Certain embodiments of the present disclosure provide a method of composing a moving object in one image. The method includes: detecting one or more movement areas from one or more continuously input images; determining whether the detected one or more movement areas are usable for composing; storing location information of the one or more movement areas together with images corresponding to the detected one or more movement areas when the one or more movement areas are usable; generating a composite image by using images corresponding to the stored one or more movement areas and the location information of the one or more movement areas; and displaying the generated composite image on a preview screen area located in a display screen.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a block diagram of an image composing apparatus according to embodiments of the present disclosure;

FIGS. 2A and 2B illustrate photographs for explaining a process of detecting a movement area in continuously photographed images according to embodiments of the present disclosure;

FIG. 3 illustrates a photograph for explaining a displaying procedure in a preview screen for image composing on a screen under continuous photographing; and

FIG. 4 illustrates a process for generating a composite image in which a moving object in continuous photographing is composed on one background image according to embodiments of the present disclosure.

### DETAILED DESCRIPTION

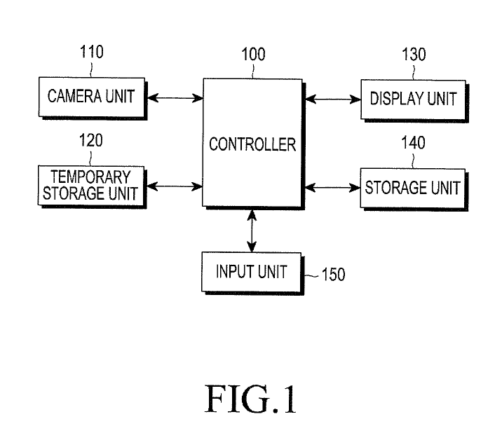

FIGS. 1 through 4, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic device. Hereinafter, embodiments of the present disclosure will be described with reference to the accompanying drawings. It will be understood that the present disclosure is not restricted or limited to the described embodiments. In the drawings, the identical reference numerals will be used to indicate identical elements which substantially perform the same function.

Terms including ordinal numbers, such as first and second, may be used to describe various elements. However, those elements are not limited by the terms. The terms are used only to distinguish an element from another element. For example, without departing from the scope of the present disclosure, a first element can be named a second structural element. Similarly, a second structural element also can be named a first structural element. Terms in the description are used to merely describe the embodiments of the present disclosure and are not intended to limit the present disclosure. A singular expression includes a plural expression unless it clearly shows contradictory meaning in the context.

FIG. 1 illustrates a block diagram of an image composing apparatus according to an embodiment of the present disclosure.

The image composing apparatus according to the present disclosure includes a controller 100, a camera unit 110, a temporary storage unit 120, a display unit 130, and a storage unit 140.

The controller 100 controls overall operations of an animation editing apparatus. In particular, if one or more images continuously photographed by the camera unit 110 are input, the controller 100 detects a movement area including a moving object from the one or more input images. That is, the controller 100 detects a movement area from the continuously photographed images while performing the continuous photography.

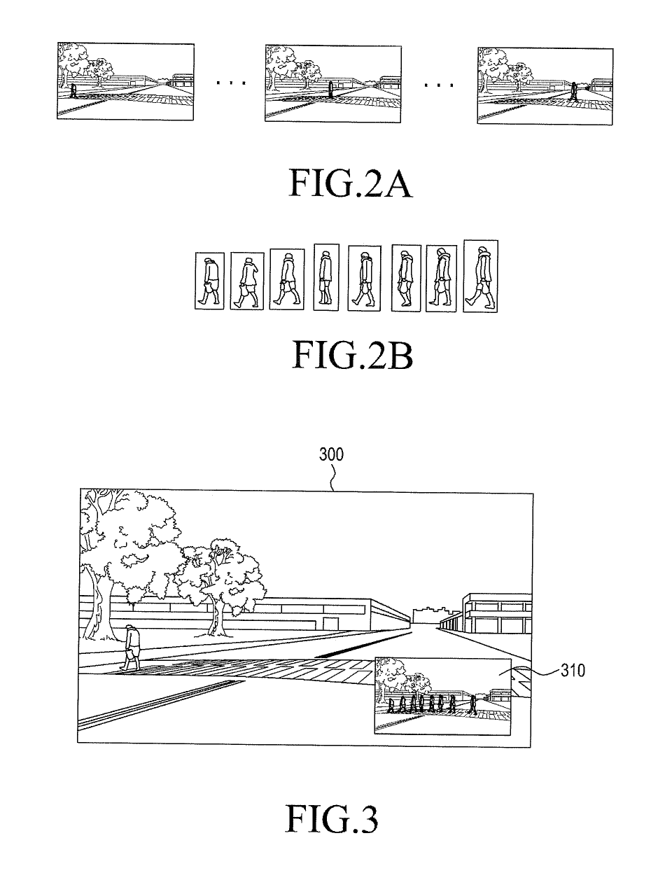

In this regard, a detailed description is provided below with reference to FIGS. 2A and 2B.

FIGS. 2A and 2B illustrate photographs for explaining a process of detecting a movement area in continuously photographed images according to embodiments of the present disclosure.

Referring to FIGS. 2A and 2B, when continuous photographing begins, one or more images are consecutively input through the camera unit 110 as shown in FIG. 2A. Then, the input one or more images are stored in the temporary storage unit 120. In the temporary storage unit 120, one or more images are consecutively stored. When the storage space of the temporary storage unit 120 is full, the stored images are sequentially deleted from the oldest image and recently input images are sequentially stored.

The controller 100 analyzes each of the images stored in the temporary storage unit 120, so as to detect a movement area including a moving object within the images. For example, the controller 100 compares a first frame with a second frame which is input next, the second frame with a third frame which is input next, . . . , and an (n−1)^{th} frame with an n^{th} frame, to determine if an area in which a pixel value difference between the corresponding images is larger than or equal to a threshold value exists.

If an area in which a pixel value difference between the corresponding images is larger than or equal to a threshold value exists, the controller 100 then determines the area, where the pixel value difference is larger than or equal to the threshold value, as a moving object, and detects a movement area of a predetermined size including the moving object as shown in FIG. 2B.

The controller 100 compares the detected movement areas of the respective images, to determine whether a movement area of a specific image overlaps a movement area of a next image. When the movement areas overlap, the controller 100 deletes the images having the overlapping movement areas. When the movement areas do not overlap, the controller 100 stores the images of the non-overlapped movement areas together with the location information of the movement areas. Here, each of the images of the movement areas refers to an image obtained by cutting out and taking only the movement area from the entire input images.

The controller 100 generates a composite image in which images of movement areas stored in the storage unit 140 are consecutively composed on a base image. The generated composite image corresponds to a preview image displayed in a preview screen area located on a screen of the display unit 130. The controller 100 may output the preview image after adjusting the size of the preview image to be appropriate for the size of the preview screen. In addition, the base image in the present disclosure may be the first image among the continuously photographed images.

Here, a detailed description will be given with reference to FIG. 3.

FIG. 3 illustrates a photograph for explaining a displaying procedure in a preview screen for image composing on a screen under continuous photographing.

Referring to FIG. 3, the controller 100 outputs the generated composite image in a preview screen area 310 for outputting a preview of the composite image, which is located at a lower-right end of a screen 300 of the display unit 130. The generated composite image does not correspond to a finally generated composite image but rather corresponds to a preview image of a composite image, which is provided to a user and can be produced through a continuous photography.

Then, if a request for generating a composite image is input through the input unit 150, the controller 100 generates a composite image corresponding to the preview image output in the preview screen area 310 and outputs the generated composite image.

In the present disclosure, it is possible to automatically perform the start and end of the continuous photographing. The controller 100 controls the camera unit 110 to start photographing when detecting motion from an input image while monitoring the input image, and controls the camera unit 110 to stop photographing when the motion is not detected any more. For example, the controller 100 starts photographing when movement from one end to the other end of an image is detected, and stops photographing when the movement is no longer detected. Further, the controller 100 stops the photographing if another object is detected in a trajectory of a moving object, a moving object reverses its direction, or the motion of the moving object is not detected for more than a predetermined time, during the continuous photographing.

The camera unit 110 receives an optical signal and outputs an image.

The temporary storage unit 120 stores one or more images which are input continuously. If the storage space is full, the stored images are sequentially deleted from the oldest image, and the most recently input images are sequentially stored.

The display unit 130 can be implemented by a Liquid Crystal Display (LCD) and displays various pieces of information provided to or input by the user, including various function menus executed in the unit. The display unit 130 can include various units as well as the LCD. Specifically, the display unit 130 of the present disclosure outputs a composite image and outputs a preview image.

The storage unit 140 stores signals or data which are input or output corresponding to the operations of the camera unit 110, the display unit 130, and the input unit 150 under the control of the controller 100. The storage unit 140 stores control programs and applications for controlling the device or the controller 100. Specifically, in this disclosure, the storage unit 140 stores images corresponding to one or more detected movement areas.

The input unit 150 includes a key input means including a plurality of keys for key input, a pointing input means (e.g., a mouse) for pointing input, and a touch input means for a touch input. Input signals received through these means are transmitted to the controller 100.

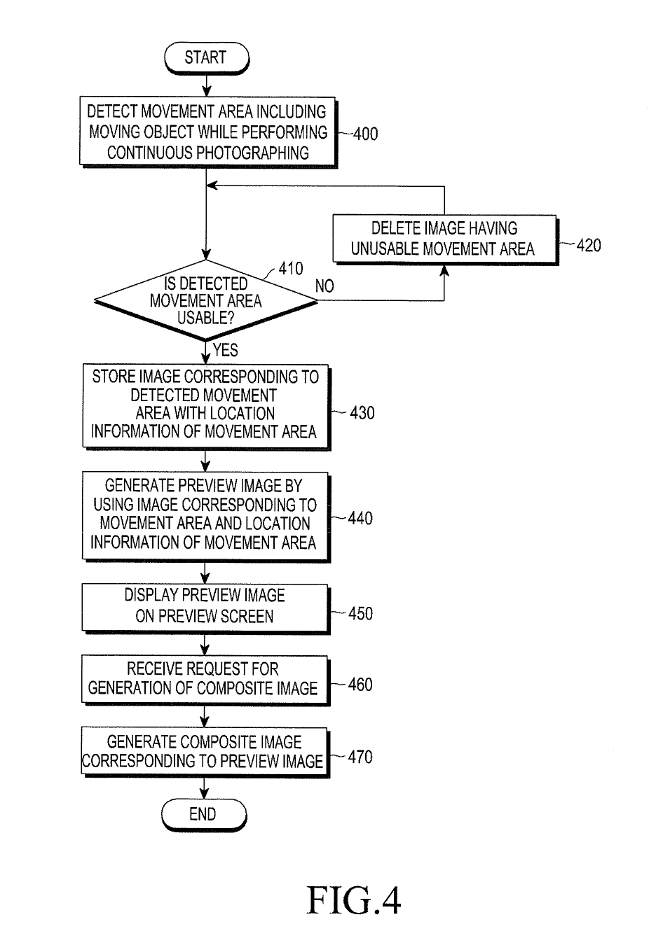

FIG. 4 is a illustrates a process for generating a composite image in which a moving object in continuous photographing is composed on one background image according to an embodiment of the present disclosure.

In block 400, the controller 100, while performing the continuous photographing, detects a movement area including a moving object from one or more input images.

In block 410, the controller 100 determines if the detected movement area is usable. When the detected movement area is usable, the controller proceeds to block 430. When the detected movement area is unusable, the controller proceeds to block 420.

Specifically, the controller 100 determines a movement area overlapping with a first movement area, among the detected movement areas, as an unusable movement area, and determines a movement area which does not overlap with the first movement area, as a usable movement area.

In block 420, the controller 100 deletes images each having an unusable movement area. Then, the controller 100 proceeds to block 410 in which the controller 100 determines whether the remaining movement areas except for the unusable areas are usable.

In block 430, the controller 100 temporarily stores the location information of the movement area with images corresponding to the one or more usable movement area in the temporary storage unit 120.

In block 440, the controller 100 generates a preview image by using the images corresponding to the one or more temporarily stored movement areas and the location information of the movement area. Specifically, the controller 100 disposes images corresponding to respective movement areas in a first image, which serves as a base image among the continuously photographed images, according to location information of the movement areas, and then generates a composite image composed of the first image and the disposed images. The location information of the movement areas can be coordinate information of the movement areas. In other words, the controller 100 disposes images of temporarily stored movement areas at locations of the movement areas, and then generates a composite image composed of the disposed images.

Thereafter, the controller 100 generates a preview image by adjusting the size of the composite image to the size of the preview area located in the display screen. In another embodiment, the controller 100 adjusts, in advance, the size of one or more images input through continuous photographing to the size of the preview area. By generating a composite image by using one or more size-adjusted images, the embodiments of the present disclosure can reduce the storage space used for those movements and the time required for the composing.

In block 450, the controller 100 displays the generated preview image on the preview screen.

In block 460, when a request for generating the composite image is received, the controller 100 generates a composite image corresponding to the preview image in block 470. Specifically, the controller 100 displays the preview image generated in the continuous photographing on the preview screen area located in the screen of the display unit 130. At this time, the displayed preview image is displayed as indicated by reference numeral 310 in FIG. 3. When a request for generating a composite image for a corresponding preview image is received through the input unit 150, the controller 100 generates a composite image corresponding to the requested preview image.

The above description of the embodiments of the present disclosure is based on an example in which the controller encodes and decodes an input image and analyzes the movement of an object in each image. However, separate components for performing these functions can be configured, such as an image processor which encodes and decodes an image, an image analyzer which analyzes each image and detects a moving object, and an image composing unit which composes images.

Thus, embodiments of the present disclosure can reduce storage space required for image composing and can achieve a rapid composing by a smaller amount of processing time.

It will be appreciated that the embodiments of the present disclosure can be implemented in the form of hardware, software, or a combination of hardware and software. Any such software can be stored in a volatile or non-volatile storage device such as a ROM, or in a memory such as a RAM, a memory chip, a memory device or a memory integrated circuit, or in a storage medium, such as a Compact Disc (CD), a Digital Versatile Disc (DVD), a magnetic disk or a magnetic tape, which is optically or magnetically recordable and simultaneously, is readable by a machine (e.g., a computer), regardless of whether the software can be deleted or rewritten. The image composing method of this disclosure can be configured by computer or portable terminal including controller and memory, also the memory is an example of a program including directions realizing the embodiments of this disclosure and storing media good for storing, readable by machine. Accordingly, embodiments of the present disclosure include a program including codes for implementing an apparatus or a method which is claimed in any claim of this specification, and a storage medium which stores this program and is readable by a machine (computer, and the like) which stores the program. In addition, these programs may be transferred electronically by arbitrary media like communication signal delivered via wire or wirelessly, or a way this disclosure properly includes as equivalent.

Further, the image composing apparatus receives and stores the program from the server which is connected via a wireless connection or wirelessly. The server can include a program which includes directions to cause the image composing apparatus to perform a set image composing method, a memory which stores information needed for an image composing method, a communication unit for performing a wired or wireless communication with the image composing apparatus, and a controller which transmits the program to the image composing device either automatically or in response to a request from the image composing apparatus.

Although the present disclosure has been described with an example, various changes and modifications may be suggested to one skilled in the art. It is intended that the present disclosure encompass such changes and modifications as fall within the scope of the appended claims.

What is claimed is:

1. An apparatus for composing a moving object in one image, comprising:
a camera unit configured to continuously photograph one or more images; and
a controller configured to:
detect one or more movement areas from the one or more images input through the camera unit,
determine whether the detected one or more movement areas are usable for composing,
in response to determining the one or more movement areas are usable, store location information of the one or more movement areas together with images corresponding to the detected one or more movement areas,
generate a composite image by using images corresponding to the stored one or more movement areas and the location information of the one or more movement areas, and
display the generated composite image on a preview screen area located in a display screen.

2. The apparatus of claim 1, wherein the controller is further configured to:
in response to determining the one or more movement areas are not usable for the composing, delete an original image including the movement area which is not usable for the composing.

3. The apparatus of claim 1, wherein the controller is further configured to: determine a movement area overlapping with a first movement area, which is a base among the one or more detected movement areas.

4. The apparatus of claim 3, wherein the controller is further configured to store an image corresponding to a movement area that does not overlap with the first movement area, among the one or more detected movement areas, and location information of the movement area that does not overlap with the first movement area.

5. The apparatus of claim 3, wherein the controller is further configured to delete an image corresponding to the movement area overlapping with the first movement area among the one or more detected movement areas.

6. The apparatus of claim 4, wherein the controller is further configured to:
generate a composite image by sequentially composing images corresponding to movement areas on the base image, which do not overlap with the first movement area,
adjust a size of the generated composite image to correspond to a size of the preview screen area, and then display the generated composite image on the preview screen area.

7. The apparatus of claim 6, wherein, in response to receiving a request for generation of a composite image, the controller is further configured to generate a composite image of an original size corresponding to the composite image displayed in the preview screen area.

8. A method of composing a moving object in one image, comprising:
detecting one or more movement areas from one or more continuously input images;
determining whether the detected one or more movement areas are usable for composing;
storing location information of the one or more movement areas together with images corresponding to the detected one or more movement areas when the one or more movement areas are usable;
generating a composite image by using images corresponding to the stored one or more movement areas and the location information of the one or more movement areas; and
displaying the generated composite image on a preview screen area located in a display screen.

9. The method of claim 8, further comprising, in response to determining the detected one or more movement areas include a movement area which is not usable for the composing, deleting an original image including the movement area that is not usable for the composing.

10. The method of claim 8, wherein determining whether the detected one or more movement areas are usable for composing comprises determining a movement area overlapping with a first movement area, which is a base among the one or more detected movement areas.

11. The method of claim 10, further comprising storing:
an image corresponding to a movement area that does not overlap with the first movement area, among the one or more detected movement areas, and
location information of the movement area that does not overlap with the first movement area.

12. The method of claim 10, further comprising deleting an image corresponding to the movement area overlapping with the first movement area among the one or more detected movement areas.

13. The method of claim 11, wherein generating of the composite image comprises:
generating a composite image by sequentially composing images corresponding to movements areas on a base image, which do not overlap with the first movement area.

14. The method of claim 13, wherein displaying of the generated composite image on the preview screen area comprises:
adjusting a size of the generated composite image to correspond to a size of the preview screen area; and
displaying the generated composite image on the preview screen area.

15. The method of claim 8, further comprising, in response to receiving a request for generation of a composite image, generating a composite image of an original size corresponding to the composite image displayed in the preview screen area.

16. A non-transitory computer-readable medium encoded with executable instructions that, when executed, cause processing circuitry to:
cause a camera unit to continuously photograph one or more images;
detect one or more movement areas from the one or more images input through the camera unit;
determine whether the detected one or more movement areas are usable for composing;
in response to determining the one or more movement areas are usable, store location information of the one or more movement areas together with images corresponding to the detected one or more movement areas;
generate a composite image by using images corresponding to the stored one or more movement areas and the location information of the one or more movement areas; and
display the generated composite image on a preview screen area located in a display screen.

17. The computer-readable medium of claim 16, wherein the instructions that cause the processing circuitry to:
in response to determining the one or more movement areas are not usable for the composing, delete an original image including the movement area which is not usable for the composing.

18. The computer-readable medium of claim 16, wherein the instructions that cause the processing circuitry to:
determine a movement area overlapping with a first movement area, which is a base among the one or more detected movement areas.

19. The computer-readable medium of claim 18, wherein the instructions that cause the processing circuitry to:
store an image corresponding to a movement area that does not overlap with the first movement area, among the one or more detected movement areas, and location information of the movement area that does not overlap with the first movement area.

20. The computer-readable medium of claim 19, wherein the instructions that cause the processing circuitry to:
generate a composite image by sequentially composing images corresponding to movement areas on the base image, which do not overlap with the first movement area,
adjust a size of the generated composite image to correspond to a size of the preview screen area, and then display the generated composite image on the preview screen area.
